(19) United States
(12) Patent Application Publication
(10) Pub. No.: US 2026/0213161 A1
(43) Pub. Date: Jul. 23, 2026

(54) A CARBON COATED SILCON-GRAPHITE COMPOSITE ANODE MATERIAL FOR RECHARGEABLE LI-ION BATTERIES AND METHOD OF PREPARATION THEREOF

(71) Applicant: EPSILON ADVANCED MATERIALS PRIVATE LIMITED, Maharashtra (IN)

(72) Inventor: Chinnasamy Natarajan, Tamil Nadu (IN)

(73) Assignee: EPSILON ADVANCED MATERIALS PRIVATE LIMITED, Maharashtra (IN)

(21) Appl. No.: 19/145,049

(22) PCT Filed: Dec. 27, 2023
(86) PCT No.: PCT/IB2023/063276

§ 371 Date: Jul. 1, 2025

(30) Foreign Application Priority Data
Jan. 2, 2023 (IN) 202321000159

(51) Int. Cl. H01M 4/36; H01M 4/02; H01M 4/04; H01M 4/38; H01M 4/583; H01M 4/62; H01M 4/66; H01M 4/75; H01M 10/0525; H01M 50/109

(52) U.S. Cl. CPC H01M 4/364; H01M 4/0404; H01M 4/0471; H01M 4/366; H01M 4/386; H01M 4/583; H01M 4/623; H01M 4/625; H01M 4/661; H01M 4/75; H01M 10/0525; H01M 50/109; H01M 2004/027

(57) ABSTRACT

The present disclosure relates to a carbon coated Silicon-Graphite composite anode material. The present disclosure also relates to a method of preparing a carbon coated Silicon-Graphite composite anode material. The present disclosure also provides a Li-ion coin cell. The carbon coating of Si-Graphite composite binds the Si nano particles on graphite matrix during Lithiation/delithiation reactions, enhancing the electrochemical cycling stability of Si-Graphite anode material, which accomplish the essential criteria of Li-ion battery anode.

### FIELD OF THE INVENTION

The present disclosure relates to a carbon coated Silicon-Graphite composite anode material for rechargeable Li-ion batteries. The present disclosure also relates to a method of preparing a carbon coated Silicon-Graphite composite negative electrode material for rechargeable Li-ion batteries. The present disclosure also discloses a Li-ion coin cell.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

In recent years, the necessity of rechargeable batteries in electronic gadgets ranging from mobile phones to smart watches, environment friendly electronic vehicles, created a meteoric rise in demand for Li ion batteries, due it's supreme electrochemical performance.

Graphite is the successful negative electrode material for Li-ion batteries. However, its theoretical capacity is 372 mAh/g and commercially available material gives close to 350-365 mAh/g, reaching its real-world maximum level. This signifies the need for development of alternative negative active material with higher capacity.

Amongst all anode material, Si from Group IV is the premier choice of negative anode material, Li_{4.4}Si Lithiated phase of Si alloying with Li during Lithiation/delithiation exhibits high theoretical capacity of 4300 mAh/g is the superior option of negative anode material. But Si shows poor life cycle, due to large volume expansion and less stable SEI layer during Lithiation/delithiation resulting in poor coulombic efficiency. About 300 % of volume expansion at the time of Li alloying with Si and pulverization of active material by large mechanical stress, maximize the loss of contact between the active material and increase charge transfer resistance exhibits high-capacity fading leads to poor electrochemical performance and poor life cycle.

These factors Limits the usage of Si active anode material in Li-ion batteries, The above-mentioned problems can be countered with various approaches like reducing the particle size into nano level like Si nano particle, Si Nanowire and Si dispersed in material matrix and Si into thin films. Generally, carbon based conductive material matrix have been used to enhance the conductivity by accommodating volume expansion during electrochemical reaction, contributing to better cycling stability with high cell capacity.

Various methods of making Si-Graphite composite and their shortcomings are as follows, nano Si particles directly mixed to Graphite as composite for negative active material. However, Si nano particles not properly mixed in the composite making agglomeration of Si particles leading to poor electrochemical performance. In another modified Manufacture process, negative electrode material metal/metal oxide film is coated on the substrate by magnetron sputtering deposition method. The method of Si/carbon composite comprises of mixing Silicon phase particle with pyrolytic carbon of organic compound undergoing carbonization treatment, cracking, and breaking to increase the electrochemical performance. Silicon alloys coated with conductive carbon layer. This method of carbon coating provides sufficient voids for volume expansion during lithiation/delithiation reaction. However, in the carbon coating method, carbonization can be performed at higher temperatures up to 1200° C. While increasing the temperature of carbon coating, crystallinity of the active material increased, and volume expansion problems occurs rapidly leading to poor electrochemical performance. In the prior art different methods have been proposed for the manufacturing of Si-graphite composite as negative material for batteries.

There are several methods to disperse the Si nano particles on conductive material matrix. Solid phase mixing method is one of the methods to disperse the Si nano particle in which graphite layers having Si nano particles on the surface produced by mechano-chemical milling using pitch as a binder. The dispersion of nano silicon into primary particles would be difficult in dry dispersion. It may need very high energy dispersion, which may damage the graphite particle. If Si nano particles placed on the surface of graphite layers manufactured by solid phase mixing, Si and graphite particles are not in close contact with Graphite and large amount of Si particles exposed to electrolyte makes adverse effects on electrochemical performance. The electrochemical reaction taken on the surface only increases the thickness of SEI layer which act as blocking layer and volume expansion occurs in the subsequent cycles. Further electrochemical reaction and capacity fading decreases the cycling stability.

CN103730644B discloses the method of preparing Silicon-silicon oxide-carbon composite negative pole material of the lithium-ion battery, mix with pitch after Silicon oxide, silicon and graphite ball milling together, high temperature heat treatment carried (500 to 1100° C.) to obtain Si oxide carbon composite negative electrode element for Li-ion batteries. But life cycle efficiency is low.

Chemical vapour deposition of Si nano particles on the surface of graphite layers is the other method of producing Si-Graphite composite. US20200148545 discloses the synthesis of carbon coated Silicon oxide graphite composite by chemical vapour deposition. This method requires higher capital cost to scale up the production.

CN105895873A disclosed the Si carbon composite anode material prepared by inductive coupled plasma method. Nano Si and organic carbon source dispersed, and graphite is mixed and carbonized. Induction plasma system treated at 5000-12000° C. to hot environment, gasifies Si flour, to obtain gaseous state Si. This would be expensive and would be difficult to scale for large scale manufacturing.

Liquid phase dispersion method to manufacture Si-Graphite composite in which Si nano particles embedded in the graphite layers, voids and cracks. This liquid phase method is more advantageous than other to make the raw materials disperse more eventually, the third phase substance i.e., the amorphous carbon coating tightly bonded with nano Si-Graphite composite enhances the conductivity of active material improving better electrochemical reaction. In the case of liquid phase method, Si nano particles embedded in the graphite voids and pores, well dispersed Si nano particles on the graphite layers leads to the increase in active site for electrochemical reaction. Moreover, carbon coating over Si-graphite composite avoids direct contact between the nano Si and the electrolyte

CN106328898A disclosed Li-ion battery anode composite material through a template method. Adding NaCl, artificial graphite, SiO, organic compound used as carbon source mixed into homogenous solution and carbonized at 500-1200° C. in inert atmosphere forms composite anode material. In this template method, temperature plays an important role in controlling the morphology, increasing temperature surge the crystallinity of particles and the concentration of organic compounds limits the carbon coating thickness.

To overcome these hindrances, the present novel method is carried out to manufacture carbon conductive layer coated Si-Graphite composite as negative active material for energy applications.

### OBJECTS OF THE INVENTION

An objective of the present invention is to provide a method of preparing a carbon coated Silicon-Graphite composite anode material for rechargeable Li-ion batteries.

Another objective of the present disclosure is to provide a carbon coated Silicon-Graphite composite anode material for rechargeable Li-ion batteries.

Yet another objective of the present disclosure is to provide a Li-ion coin cell.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, explain the principles of the present disclosure.

FIG. 1 showed process flow diagram.

FIG. 2 showed surface morphology of Carbon coated Si-Graphite composite.

FIG. 3 showed elemental mapping of Example 1 (Black: Carbon; Green Si)

FIG. 4 showed elemental mapping of Comparative Example 1 (Black: Carbon; Green Si)

FIG. 5 showed elemental mapping of Comparative Example 2 (Black: Carbon; Green Si)

FIG. 6 showed electrochemical studies of Si-Graphite composite.

### SUMMARY OF THE INVENTION

This summary is provided to introduce a selection of concepts in a simplified form that are further described below in Detailed Description section. This summary is not intended to identify key features or essential features of the claimed subject matter, nor is it intended to be used as an aid in determining the scope of the claimed subject matter.

An aspect of the present disclosure is to provide a method of preparing a carbon coated Silicon-Graphite composite anode material for rechargeable Li-ion batteries comprising: i) dispersing 2 to 15% w/v of a silicon nano particles in a polar solvent followed by sonicated to obtain a dispersed solution; ii) adding 30 to 50% w/v of a coal tar oil in the dispersed solution with stirring to obtain a first mixture; iii) adding 5 to 30% w/v of a carbon source to the first mixture with stirring under condition to obtain a second mixture; iv) homogenizing the second mixture to obtain a first homogenized mixture; v) dispersing a 85 to 98% w/v of graphite in a solvent followed by adding it into the homogenized mixture of step iv) to obtain a second homogenized mixture; vi) separating the second homogenized mixture by fractional distillation to evaporate the solvent and the coal tar oil, and a silicon-graphite-pitch composite residue; and vii) carbonizing the silicon-graphite-pitch composite residue to obtain a carbon coated silicon-graphite composite anode material.

Another aspect of the present disclosure is to provide a carbon coated Silicon-Graphite composite anode material for rechargeable Li-ion batteries comprising: 2 to 15 weight % of silicon nanoparticles; 5 to 30 weight % of carbon; and 85 to 98 weight % of graphite.

Another aspect of the present disclosure is to provide a Li-ion coin cell comprising of a copper foil current collector; and a slurry comprising 80-90% of a carbon coated Silicon-Graphite composite anode material, 4-8 wt % of a conductive additive, 3-5 wt % of a dispersant and 5-7 wt % of a binder; wherein the said slurry is uniformly coated on the copper foil current collector.

Various objects, features, aspects and advantages of the inventive subject matter will become more apparent from the following detailed description of preferred embodiments.

### DETAILED DESCRIPTION OF THE INVENTION

The following is a detailed description of embodiments of the disclosure. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Unless the context requires otherwise, throughout the specification which follow, the word “comprise” and variations thereof, such as, “comprises” and “comprising” are to be construed in an open, inclusive sense that is as “including, but not limited to.”

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The recitation of ranges of values herein is merely intended to serve as a shorthand method of referring individually to each separate value falling within the range. Unless otherwise indicated herein, each individual value is incorporated into the specification as if it is individually recited herein.

All processes described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

The headings and abstract of the invention provided herein are for convenience only and do not interpret the scope or meaning of the embodiments.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description that follows, and the embodiments described herein, is provided by way of illustration of an example, or examples, of particular embodiments of the principles and aspects of the present disclosure. These examples are provided for the purposes of explanation, and not of limitation, of those principles and of the disclosure.

It should also be appreciated that the present invention can be implemented in numerous ways, including as a system, a method or a device. In this specification, these implementations, or any other form that the invention may take, may be referred to as processes. In general, the order of the steps of the disclosed processes may be altered within the scope of the invention.

Various terms as used herein are shown below. To the extent a term used in a claim is not defined below, it should be given the broadest definition persons in the pertinent art have given that term as reflected in printed publications and issued patents at the time of filing.

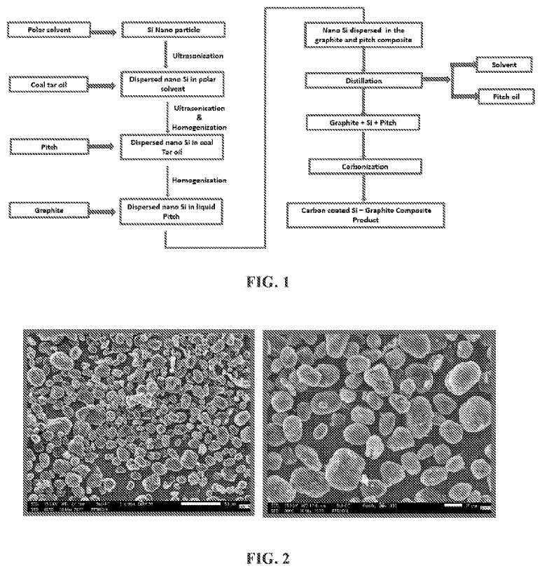

An embodiment of the present disclosure is to provide a method of preparing a carbon coated Silicon-Graphite composite anode material for rechargeable Li-ion batteries comprising: i) dispersing 2 to 15 % w/v of a silicon nano particles in a polar solvent followed by sonicated to obtain a dispersed solution; ii) adding 30 to 50 % w/v of a coal tar oil in the dispersed solution with stirring to obtain a first mixture; iii) adding 5 to 30% w/v of a carbon source to the first mixture with stirring under condition to obtain a second mixture; iv) homogenizing the second mixture to obtain a first homogenized mixture; v) dispersing a 85 to 98 % w/v of graphite in a solvent followed by adding it into the homogenized mixture of step iv) to obtain a second homogenized mixture; vi) separating the second homogenized mixture by fractional distillation to evaporate the solvent and the coal tar oil, and a silicon-graphite-pitch composite residue; and vii) carbonizing the silicon-graphite-pitch composite residue to obtain a carbon coated silicon-graphite composite anode material. FIG. 1 shows the production process flow.

In a preferred embodiment, the method of preparing a carbon coated Silicon-Graphite composite anode material for rechargeable Li-ion batteries comprising: i) dispersing 5 to 10 % w/v of a silicon nano particles in a polar solvent followed by sonicated to obtain a dispersed solution; ii) adding 30 to 50 % w/v of a coal tar oil in the dispersed solution with stirring to obtain a first mixture; iii) adding 10 to 20 % w/v of a carbon source to the first mixture with stirring under condition to obtain a second mixture; iv) homogenizing the second mixture to obtain a first homogenized mixture; v) dispersing 90 to 95% w/v of graphite in a solvent followed by adding it into the homogenized mixture of step iv) to obtain a second homogenized mixture; vi) separating the second homogenized mixture by fractional distillation to evaporate the solvent and the coal tar oil, and a silicon-graphite pitch composite residue; and vii) carbonizing the silicon-graphite pitch composite residue to obtain a carbon coated silicon-graphite composite anode material.

In an embodiment, the polar solvent is selected from any aqueous protic or aprotic solvent having dielectric constant between 5 to 40 and high miscibility, compatibility with coal tar and combination thereof.

In an embodiment, the sonication in step i) is carried out for a period in the range of 30 to 180 min. Preferably, the time period for sonication is 60 min.

In an embodiment, the stirring in step ii) is carried out continuously for a period in the range of 30 to 180 min. Preferably, the stirring is carried out for 60 min.

In an embodiment, the carbon source in step iii) is selected from a group consisting of crushed coal tar, petroleum tar pitch, resin, and combination thereof. Preferably, the carbon source is pitch.

In an embodiment, the condition in step iii) includes temperature in the range of 50 to 100° C. for a period in the range of 30 to 180 min. Preferably, the condition includes temperature at 80° C. for a period of 60 min.

In an embodiment, the homogenization in step iv) is carried out at a temperature in the range of 80 to 100° C. for a period in the range of 30 to 180 min. Preferably, the homogenization is carried out at a temperature of 90° C. for a period of 60 min.

In an embodiment, the solvent in step v) is selected from a group of polar consisting of acetone, ethanol, isopropyl alcohol and n-butanol and combination thereof. The solvent that have dielectric constant between 10 to 30 like acetone, ethanol, isopropyl alcohol, n-butanol etc. and combination thereof can be used Preferably, the solvent has dielectric constant of between 20 to 30 and the solvent is completely miscible in coal tar based oil.

In an embodiment, the graphite is dispersed in the solvent in step v) for a period in the range of 5 to 15 min. Preferably, the graphite is dispersed in solvent for 10 min.

In an embodiment, the homogenous mixture is fractionally distilled from room temperature (about 20 to 35° C.) to 300° C. In an embodiment, the solvent in step vi) is evaporated at a temperature in the range of 70 to 90° C. and coal tar oil is removed at a temperature in the range of 250 to 270° C. Preferably, the solvent is evaporated at 80° C. and coal tar oil is removed at 260° C.

In an embodiment, the silicon-graphite-pitch composite residue is carbonized in step vii) in inert atmospheric condition at a temperature in the range of 600 to 1200° C., preferably, 600 to 1000° C. The inert atmospheric condition includes Ar, N₂ and/or CO₂.

In an embodiment, the carbon coated silicon-graphite composite of step vii) has a size in the range of 15 to 20 μm.

Another aspect of the present disclosure is to provide a carbon coated Silicon-Graphite composite anode material for rechargeable Li-ion batteries comprising: 2 to 15 weight % of silicon nanoparticles; 5 to 30 weight % of carbon; and 85 to 98 weight % of graphite.

In a preferred embodiment, the carbon coated Silicon-Graphite composite anode material for rechargeable Li-ion batteries comprising: 2 to 8 weight % of silicon nanoparticles; 10 to 20 weight % of carbon; and 88 to 92 weight % of graphite.

Another aspect of the present disclosure is to provide a Li-ion coin cell comprising of a copper foil current collector; and a slurry comprising 80-90% of a carbon coated Silicon-Graphite composite anode material, 4-8 wt % of a conductive additive, 3-5 wt % of a dispersant and 5-7 wt % of a binder; wherein the said slurry is uniformly coated on the copper foil current collector.

In a preferred embodiment, the Li-ion coin cell comprising of a copper foil current collector; and a slurry comprising 84 wt % of a carbon coated Silicon-Graphite composite anode material, 6 wt % of a conductive additive, 4 wt % of a dispersant and 6 wt % of a binder; wherein the said slurry is uniformly coated on the copper foil current collector.

In an embodiment, the conductive additive is selected from a group consisting of carbon black, carbon nano tubes (CNTs) and reduced graphene oxides (RGOs) and combination thereof. The conductive additive is selected from material having high electronic conductivity. Preferably, the conductive additive is carbon black, carbon nano tubes (CNTs) and reduced graphene oxides (RGOs) and combination thereof.

In an embodiment, the dispersant is selected from a group consisting of carboxy methyl cellulose, N-methyl pyrrolidine and combination thereof. The dispersant is selected from any aqueous or non-aqueous based surfactant material having the tendency to form structures or aggregates called micelles in the bulk aqueous or non-aqueous phase and combination thereof. Preferably, the dispersant like carboxy methyl cellulose, N-methyl pyrrolidine etc and combination thereof.

In an embodiment, the binder is selected from a group consisting of styrene butadiene (SBR), Polyvinylidene fluoride (PVDF), Polyacrylic acid (PAA) and combination thereof. The binder is selected from any aqueous or non-aqueous based polymer. The polymer has high elasticity, strong adhesive, self-healing, ionic or electronic conductivity and combination thereof. Preferably, the binder used is styrene butadiene (SBR), Polyvinylidene fluoride (PVDF), Polyacrylic acid (PAA) and combination thereof.

The present disclosure involves the method of preparing carbon coated Si-Graphite composite anode for rechargeable Li-ion batteries. The process involves dispersion of nano silicon into homogenous slurry followed by carbon binder addition to fix it on Graphite surface and coat the carbon on silicon/graphite in the same step. The coating of carbon on silicon and graphite is processed with the following step: dispersion and homogenization of nano Silicon in non-polar solvent/tar-based oils and then addition graphite followed by second homogenization to get nano silicon dispersed on Graphite slurry. The mixture is then distilled to remove solvent and then composite is carbonized to make Graphite-Si composite electrode material. After Carbonization, the final product is milled into fine powder and studied as anode material for Li-ion battery applications. This slurry making process have multiple steps and sequence of mixing to have good homogenization resulting in carbon coated Si-Graphite composite with well dispersed/embedded Si nano particles without agglomeration in the Graphite matrix. The carbon coating of Si-Graphite composite binds the Si nano particles on graphite matrix during Lithiation/delithiation reactions, enhancing the electrochemical cycling stability of Si-Graphite anode material, which accomplish the essential criteria of Li-ion battery anode.

While the foregoing describes various embodiments of the disclosure, other and further embodiments of the disclosure may be devised without departing from the basic scope thereof. The invention is not limited to the described embodiments, versions or examples, which are included to enable a person having ordinary skill in the art to make and use the invention when combined with information and knowledge available to the person having ordinary skill in the art.

### EXAMPLES

The present invention is further explained in the form of the following examples. However, it is to be understood that the following examples are merely illustrative and are not to be taken as limitations upon the scope of the invention.

### Example 1

5-10 % w/v of Si nano particles were dispersed in a polar solvent. Solution was sonicated/homogenized to disperse into primary Si nano particle for 60 min to obtain a dispersed solution. 30 to 50 (% of w/v) of coal tar oil was added to the dispersed solution with continuously stirred for 60 min to obtain a first mixture. 10 to 20 (wt. %) of well crushed coal tar as carbon source was added in coal tar oil and nano silicon containing first mixture and stirred at 70° C. to 60 min to obtain a second mixture. The second mixture was homogenized at 90° C. for 60 min to obtain a homogenous solution A. 90 to 95 (wt. % or gm) of Graphite was dispersed in acetone for 10 minutes and added to A to obtain a homogenized mixture of B. Homogenous mixture B was fractionally distilled from room temperature to 300° C. Acetone was evaporated at 80° C. and at 260° C. coal tar oil was removed. All the coal oil was removed; the residue, Si-Graphite-pitch composite was collected. The Si-Graphite-pitch composite was carbonized in inert condition at 600 to 1000° C. to obtain a carbon coated Si-Graphite composite. The composite was crushed and sieved to make electrodes (Li-ion coin cell) for testing. The electrode (Li-ion coin cell) was prepared from a copper foil current collector; and a slurry comprising 80 to 85 wt. % of a carbon coated Silicon-Graphite composite anode material, 4 to 6 wt % of a conductive additive, 3 to 4 wt. % of a dispersant and 5 to 6 wt. % of a binder; wherein the said slurry is uniformly coated on the copper foil current collector to obtain the electrode. 15 mm diameter electrode is cut and assembled as 2032 coin with Li metal as reference electrode. Mixture of 1% 1,3-Propane Sultone and 10 % Fluoroethylene carbonate is added as electrolyte additive with Commercial electrolyte (LiPF6 in EC/DMC/DEC (4:3:3)−VC<2%) have been used as electrolyte.

### Comparative Examples 1

The composite of 5 to 10 % (wt.) of nano silicon and 90 to 95 % of graphite was prepared by solid state mixing (direct method) to obtain Si-Graphite composite. The electrode is prepared from a copper foil current collector; and a slurry comprising 80 to 85 wt. % of a carbon coated Silicon-Graphite composite anode material, 4 to 6 wt % of a conductive additive, 2 to 4 wt. % of a dispersant and 3 to 6 wt. % of a binder; wherein the said slurry is uniformly coated on the copper foil current collector to obtain the electrode. 15 mm diameter electrode is cut and assembled as 2032 coin with Li metal as reference electrode. Mixture of 1% 1,3-Propane Sultone and 10 % Fluoroethylene carbonate is added as electrolyte additive with Commercial electrolyte (LiPF6 in EC/DMC/DEC (4:3:3)−VC<2%) have been used as electrolyte.

### Comparative Example 2

10 to 20 (wt. %) of well crushed coal tar preferably pitch as carbon source was added in coal tar oil and stirred at 70° C. to 60 min to obtain a first homogeneous mixture. 90 to 95 % of Graphite was dispersed in polar solvent for 10 minutes and added to the first homogenous solution to obtain a second homogenized mixture. The second mixture was homogeneously dispersed at room temperature for 20 min and added to the first homogenous solution. The obtained homogenous mixture was fractionally distilled from room temperature to 300° C. Polar solvent was evaporated at 80° C. and at 260° C. coal tar oil was removed. All the coal oil was removed; the residue, Graphite-pitch residue was collected and carbonized in inert condition at 600 to 1000° C. Graphite-pitch composite and 5 to 10 (wt % or gm) of Si nano particles were dispersed in 10 to 50 (% of w/v) of polar solvent. The graphite-pitch composite and Si mixture was sonicated/homogenized to disperse into primary Si nano particle for 20 min. Then the dispersed solution is dried @110° C. to remove the solvent. The composite was crushed and sieved into fine powder to make electrodes for testing. The electrode is prepared from a copper foil current collector; and a slurry comprising 80 to 85 wt. % of Silicon-Graphite composite anode material, 4 to 6 wt % of a conductive additive, 2 to 4 wt % of a dispersant and 3 to 6 wt % of a binder; wherein the said slurry is uniformly coated on the copper foil current collector to obtain the electrode. 15 mm diameter electrode is cut and assembled as 2032 coin with Li metal as reference electrode. Mixture of 1% 1,3-Propane Sultone and 10 % Fluoroethylene carbonate is added as electrolyte additive with Commercial electrolyte (LiPF6 in EC/DMC/DEC (4:3:3)−VC<2%) have been used as electrolyte.

### Advantages of the Present Invention

This liquid phase complex method of preparation of high performance carbon coated composite anode material which is easy to scaleup, lower capex. The electrochemical performance of the Si-graphite composite prepared liquid phase method is much improved than the Si-graphite prepared solid phase-physical mixing. The carbon coated Si-Graphite composite material can be used as a negative electrode material for energy storage material with improved electrochemical stability for long cycle life.

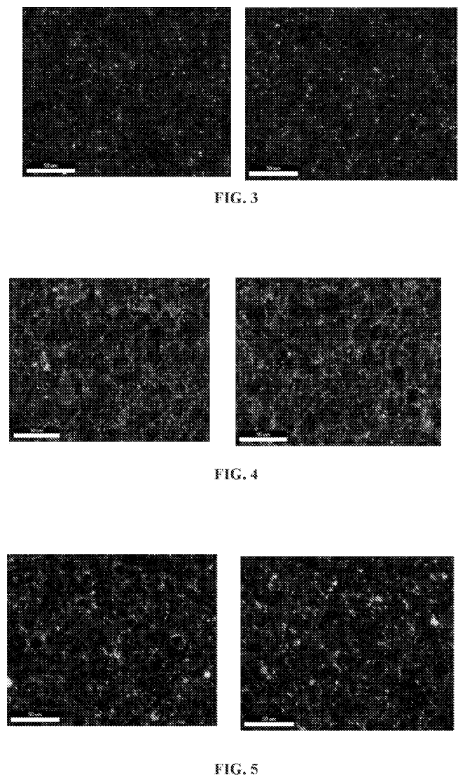

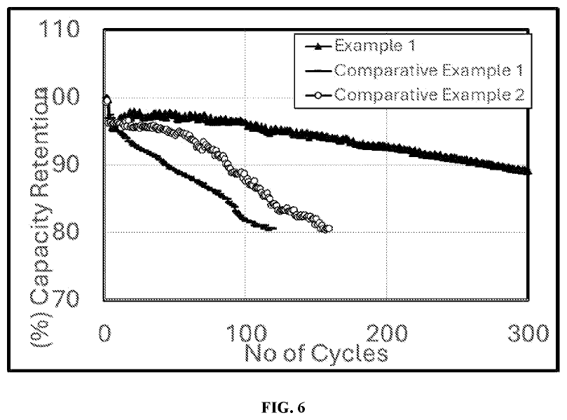

Second, Si-Graphite composite anode material was prepared by this method with low viscous polar solvents such as acetone and coal tar oil to make homogeneous mixture of well dispersed/embedded Si nano particles over graphite matrix. Nano Si particles were dispersed well on the graphite matrix and occupied into the voids and spaces due to the liquid phase dispersion method (Example 1). The uniform dispersion of Example 1 provided in the SEM image shown in FIG. 2. Elemental mapping analysis of Example 1 and comparative examples 1 & 2 shown in FIG. 3 to FIG. 5 respectively. The Si mapping analysis of material made from solid state physical mixing (Comparative Example 1) and liquid phase method in which Si dispersed after carbonization (comparative Example 2) is shown in FIG. 4. This shows more Si dispersed on the surface of the graphite and agglomerated. In FIG. 4 (Comparative example 2) shows better dispersion of Si particle in graphite though solvent dispersion. But FIG. 3 shows less Si on the surface of the graphite and more dispersed particle embedded in the graphite matrix which occupies the space and voids between the graphite layers. These non-agglomerated well dispersed Si nano particles boost the electrochemical performance of the Si-Graphite composite in the subsequent capacity cycling reaction of Lithiation/delithiation as shown in the FIG. 6. FIG. 6 showed that carbon coated 5% Si-Graphite composite active material prepared by different route of synthesis (Example 1, Comparative Example 1 & 2) as anode for Li-ion coin cells. The composite synthesized by different routes as negative material gives more than 500 mAh/g in the initial cycles. Comparative example 1 shows gradual capacity fading in the subsequent cycles and 80% capacity retention at 120 cycles. Comparative Example 2 delivers better electrochemical stability than Comparative Example 1. It shows the % of capacity retention 80 after 150 cycles. Wherein Example 1 the composites gives much better electrochemical stability than comparative examples. Example 1 shows a high % of capacity retention about 90% even after 300 cycles. This proves that the method of Si dispersion in graphite matrix is the crucial part for better electrochemical stability can be achieved by the liquid phase dispersion method. Moreover dispersion of Si particle in the appropriate stage of synthesis is beneficial to avoid the direct surface contact of Si nano particle to the electrolyte which leads to capacity fading.

Third the pores and voids in the graphite matrix provides enough space to accommodate volume expansion caused by Lithiated phase of Si leads to loss of contact between the negative active material and Si dispersed on graphite & in the voids and pores of graphite maintains the electrical conductivity.

Fourth, Carbon coating of Si-Graphite composite provides high electron conduction of the active material. This electron conduction on the top layer of Si-Graphite composite frames a good electronic network, reducing the intergranular distance for Li⁺ ion movement.

Fifth, Carbon coating over Si-Graphite composite provides an electrolyte blocking layer and internal void space of Carbon coated Si-Graphite composites furnish space for large volume expansion of Si nano particles in Lithiation/delithiation and strengthens the cycling stability of Si-Graphite composite. So, carbon coating acts as a conducting network neutralizing the internal resistance increased due to volume expansion and performs conductivity framework between the Si-graphite composite anode.

The foregoing examples are merely illustrative and are not to be taken as limitations upon the scope of the invention. Various changes and modifications to the disclosed embodiments will be apparent to those skilled in the art. Such changes and modifications may be made without departing from the scope of the invention.

We claim:

1. A method of preparing a carbon coated Silicon-Graphite composite anode material for rechargeable Li-ion batteries comprising:
i) dispersing 2 to 15 % w/v of a silicon nano particles in a polar solvent followed by sonicated to obtain a dispersed solution;
ii) adding 30 to 50 % w/v of a coal tar oil in the dispersed solution with stirring to obtain a first mixture;
iii) adding 5 to 30% w/v of a carbon source to the first mixture with stirring under condition to obtain a second mixture;
iv) homogenizing the second mixture to obtain a first homogenized mixture;
v) dispersing 85 to 98 % w/v of graphite in a solvent followed by adding it into the homogenized mixture of step iv) to obtain a second homogenized mixture;
vi) separating the second homogenized mixture by fractional distillation to evaporate the solvent and the coal tar oil, and a silicon-graphite-pitch composite residue; and
vii) carbonizing the silicon-graphite-pitch composite residue to obtain a carbon coated silicon-graphite composite anode material.

2. The method as claimed in claim 1, wherein the polar solvent is selected from any aqueous protic or aprotic solvent having dielectric constant between 5 to 40 and high miscibility, compatibility with coal tar and combination thereof.

3. The method as claimed in claim 1, wherein the sonication in step i) is carried out for a period in the range of 30 to 180 min.

4. The method as claimed in claim 1, wherein the stirring in step ii) is carried out continuously for a period in the range of 30 to 180 min.

5. The method as claimed in claim 1, wherein the carbon source in step iii) is selected from a group consisting of crushed coal tar, petroleum tar pitch, resin and combination thereof.

6. The method as claimed in claim 1, wherein the condition in step iii) includes temperature in the range of 50 to 100° C. for a period in the range of 30 to 180 min.

7. The method as claimed in claim 1, wherein the homogenization in step iv) is carried out at a temperature in the range of 80 to 100° C. for a period in the range of 30 to 180 min.

8. The method as claimed in claim 1, wherein the solvent in step v) is selected from a group of polar consisting of acetone, ethanol, isopropyl alcohol and n-butanol and combination thereof.

9. The method as claimed in claim 1, wherein the graphite is dispersed in the solvent in step v) for a period in the range of 5 to 15 min.

10. The method as claimed in claim 1, wherein the solvent in step vi) is evaporated at a temperature in the range of 70 to 90° C. and coal tar oil is removed at a temperature in the range of 250 to 270° C.

11. The method as claimed in claim 1, wherein the silicon-graphite-pitch composite residue is carbonized in step vii) in inert atmospheric condition at a temperature in the range of 600 to 1200° C.

12. The method as claimed in claim 1, wherein the carbon coated silicon-graphite composite of step vii) has a size in the range of 15 to 20 μm.

13. A carbon coated Silicon-Graphite composite anode material for rechargeable Li-ion batteries comprising:
2 to 15 weight % of silicon nanoparticles;
5 to 30 weight % of carbon; and
85 to 98 weight % of graphite.

14. A Li-ion coin cell comprising of a copper foil current collector; and a slurry comprising 80-90% of a carbon coated Silicon-Graphite composite anode material as claimed in claim 13, 4-8 wt % of a conductive additive, 3-5 wt % of a dispersant and 5-7 wt % of a binder; wherein the said slurry is uniformly coated on the copper foil current collector.

15. The Li-ion coin cell as claimed in claim 14, wherein the conductive additive is selected from a group consisting of carbon black, carbon nano tubes (CNTs) and reduced graphene oxides (RGOs) and combination thereof.

16. The Li-ion coin cell as claimed in claim 14, wherein the dispersant is selected from a group consisting of carboxy methyl cellulose, N-methyl pyrrolidine and combination thereof.

17. The Li-ion coin cell as claimed in claim 14, wherein the binder is selected from a group consisting of styrene butadiene (SBR), Polyvinylidene fluoride (PVDF), Polyacrylic acid (PAA) and combination thereof.
